(19) United States
(12) Patent Application Publication
(10) Pub. No.: US 2007/0220124 A1
(43) Pub. Date: Sep. 20, 2007

(54) System and method for automatically creating and enabling zones in a network

(75) Inventor: Richard Golasky, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/376,889

(22) Filed: Mar. 16, 2006

(51) Int. Cl. G06F 15/173

(52) U.S. Cl. 709/223

(57) ABSTRACT

A system and method for automatically creating and enabling zoning in a network are disclosed. A method includes transmitting data from a host device coupled to the network to at least one switch coupled to the network. The transmitted data includes information indicating that the host device requested access to at least one target device coupled to the network. A zone is then created and enabled comprising the host device and the at least one target device.

### TECHNICAL FIELD

The present disclosure relates in general to network communication, and more particularly to a system and method for automatically creating and enabling zoning in a network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today, networks are typically used to connect information handling systems, such as personal computers, workstations and servers, with network devices such as network attached storage devices, file servers, print servers, modems, hubs, and other devices, including but not limited to other information handling systems. Examples of such networks include Local Area Networks (LANs), metropolitan area networks (MANs), and wide area networks (WANs). These networks enable information handling systems to share information and resources. The information handling systems and network devices are often coupled to a switch fabric consisting of one or more switching devices in order to facilitate communication among the devices. Generally speaking, devices coupled to the fabric may be capable of communicating with every other device coupled to the fabric.

However, there are situations where the ability to freely communicate between all devices on a fabric may not be desirable. For example, it may be desirable to screen off certain devices on a fabric in order to perform testing and/or maintenance activities on only those devices, without risking interfering with the other devices on the fabric. Alternately, devices may be segregated according to use or for performance or security issues. For example, the devices coupled to the fabric may be segregated in one fashion during normal operation and in another fashion to facilitate back-up operations or system maintenance. As another example, different levels of security may be enforced by allowing only certain sets of devices to communicate with each other. As a further example, devices may be segregated according to operating system or other technical features.

Segregation of devices may be accomplished by physically separating the devices or coupling the devices to different switch fabrics. However, those techniques do not facilitate re-configuration of connections between devices unless a network administrator physically re-configures and re-couples the devices. In recent years, this drawback has been overcome through the use of zoning, which allows configuration and re-configuration of a fabric so as to restrict communications between sets of devices connected to the switch fabric, and to provide support for multiple configurations of device connections without the necessity of physical re-configuration.

However, existing network topologies and implementations utilizing zoning still require a significant degree of manual configuration by a network administrator, which can impose a significant investment of time and financial resources. Conventionally, implementation of zoning requires that an administrator use a management application to: administer a switch fabric, determine unique identifiers (e.g. World Wide Names (WWN) or port numbers) for the devices to be included in a particular zone, create a zone, add all desired devices to the zone, and activate the zone. If a fabric is coupled to numerous devices included in numerous zones, an administrator will need to keep track of all devices and zones and determine which devices are to have membership in each zone.

### SUMMARY

In accordance with the teachings of the present disclosure, the disadvantages and problems associated with implementing zoning on a switch fabric have been substantially reduced or eliminated. In a particular embodiment, a switch may automatically create a zone in a network based on data received from a host device.

In accordance with one embodiment of the present disclosure, a system for automatically creating and activating a zone in a network includes a host device coupled to the network and a target device coupled to the network. A switch interfaced between the host device and the target device automatically creates a zone including the host device and the target device based on data received from the host device. The data includes information indicating that the host device has requested access to the target device.

In accordance with another embodiment of the present disclosure, a system for automatically creating and activating a zone in a network includes a host device coupled to the network and a storage device coupled to the network. A switch interfaced between the host device and the storage device automatically creates a zone including the host device and the storage device based on data received from the host device. The data includes information indicating that the host has requested access to the storage device.

In a further embodiment of the present disclosure, a method of automatically creating and activating a zone in a network includes receiving data from a host device coupled to the network at a switch coupled to the network. The received data including information indicating that the host device requested access to at least one target device coupled to the network. The switch automatically creates a zone including the host device and the at least one target device based on the data received from the host device.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example network in accordance with teachings of the present disclosure;

FIG. 2 illustrates a database for storing and maintaining zoning information in accordance with the teachings of the present disclosure;

FIG. 3 illustrates a flow chart of a method for automatically creating and activating a zone in a network in accordance with teachings of the present disclosure;

FIG. 4a illustrates a table representing various fields contained within a vendor specific control descriptor block (CDB) that may be used to detect switches supporting automated zoning using small computer system interface (SCSI) over Fibre Channel protocol (SCSI FCP) in accordance with teachings of the present disclosure;

FIG. 4b illustrates a table representing various fields contained within a vendor specific CDB that may be used to request automated zoning access to a target device using SCSI FCP in accordance with teachings of the present disclosure;

FIG. 5a illustrates a table representing various fields contained within a Fibre Channel Common Transport Information Unit (FC-CT IU) that may be used to implement automatic zoning using FC-CT protocol in accordance with teachings of the present disclosure;

FIG. 5b illustrates a table representing various fields contained within the Vendor Specific Preamble field of a FC-CT IU that may be used to detect switches supporting automated zoning using FC-CT protocol in accordance with teachings of the present disclosure; and

FIG. 5c illustrates a table representing various fields contained within the Vendor Specific Preamble field of a FC-CT IU that may be used to request automated zoning access to a target device using FC-CT protocol in accordance with teachings of the present disclosure.

### DETAILED DESCRIPTION

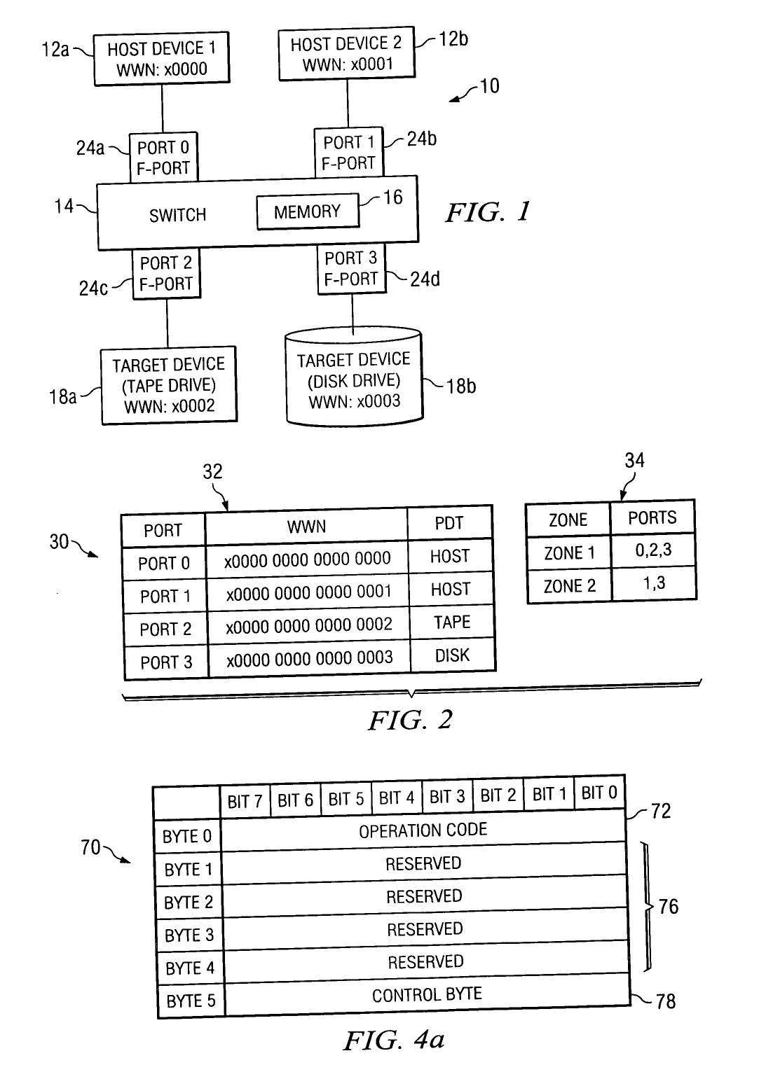

Preferred embodiments and their advantages are best understood by reference to FIGS. 1 through 5c, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 illustrates a block diagram of network 10 that supports automatic zoning. Although a specific network is illustrated in FIG. 1, the term “network” should be interpreted as generically defining any network capable of transmitting telecommunication signals, data and/or messages. In the illustrated embodiment, network 10 includes host devices 12a and 12b (generally referred to as host devices 12), switch 14, and target devices 18a and 18b (generally referred to as target devices 18).

Network 10 may be a local area network (LAN), a metropolitan area network (MAN), storage area network (SAN), a wide area network (WAN), a wireless local area network (WLAN), a virtual private network (VPN), an intranet, the Internet or any other appropriate architecture or system that facilitates the communication of signals, data and/or messages (generally referred to as media). In a particular embodiment, network 10 may transmit media using the Fibre Channel (FC) standards. Although subsequent description will primarily focus on the FC standards and FC protocols, it should be understood that other appropriate methods of transmitting media over a network, such as a Frame Relay, Asynchronous Transfer Mode (ATM), Internet protocol (IP), other packet-based protocol, or other transmission protocols and standards are also included within the scope of the present disclosure.

As shown in FIG. 1, network 10 may include one or more host devices 12 and one or more target devices 18. Although only two host devices 12 and only two target devices 18 are depicted in FIG. 1, it should be understood that network 10 may include any number of host devices 12 and target devices 18. Host devices 12 may include one or more information handling systems, as defined herein.

Additionally, although target devices 18a and 18b are depicted as a tape drive and a disk drive, respectively, target devices 18 may include one or more information handling systems (as defined herein), network devices or storage devices, for example network attached storage devices, file servers, print servers, modems, hubs and other devices capable of being coupled to network 10. Furthermore, host devices 12 and target devices 18 may be any type of processing device and may provide any type of functionality associated with an information handling system, including without limitation database management, transaction processing, storage, printing, or web server functionality.

Network 10 may additionally include switch 14. Switch 14 may be a Fibre Channel switch or any other device capable of performing switching in network 10. Although only one switch 14 is depicted in FIG. 1, it should be understood that network 10 may include more than one switch. In the illustrated embodiment, host devices 12 may be communicatively coupled to switch 14 and target devices 18 may be communicatively coupled to switch 14. Switch 14 may be a switch, router, or any other device having intelligent communications switching functionality, and may include any suitable number of ports for communicating with host devices 12, target devices 18 and/or various other devices (not expressly shown) coupled to network 10.

The identity of a device on a network (e.g., host devices 12 and target devices 18 in network 10) may typically be determined by a unique identifier. A unique identifier may include a World Wide Name (WWN) identifier, IP address or medium access control (MAC) address of the target device, a unique port number of the switch 14 to which the device is coupled, or any other suitable technique that uniquely identifies a device on a network.

Switch 14 may include memory 16 operable to store and maintain network information and zoning information. For example, memory 16 may include information indicating the unique identifiers of all host devices 12 and target devices 18 coupled to network 10 and information indicating which devices are members of each zone on network 10. Memory 16 may also include information indicating the device type of each host device 12 and each target device 18. Memory 16 may be random access memory (RAM), electronically erasable programmable read-only memory (EEPROM), a PCMCIA card, flash memory, or any suitable selection and/or array of volatile or non-volatile memory.

Switch 14 may also include numerous ports 24a-d (generally referred to as ports 24) that serve as interfaces between switch 14 and the various host devices 12 and target devices 18. Although only four ports 24 are depicted in FIG. 1, it should be understood that switch 14 may comprise any number of ports 24.

In operation, host device 12 may transmit a message over network 10 to detect whether switch 14 supports automatic zoning. Switch 14 may transmit a message which indicates the automatic zoning capability of switch 14. If switch 14 supports automatic zoning, host device 12 may transmit to switch 14 a message containing information indicating which types of target devices 18 are to be associated with the host device 12 in a zone. Switch 14 may identify all desired target devices and record the unique identifier for the target devices in memory 16 or other suitable means for recording, storing and maintaining information, such as memory coupled to the network (not shown) or memory coupled to one more devices coupled to the network (not shown). Switch 14 may attempt to create a zone including host device 12 and target device(s) 18 to be associated with host device 12. If switch 14 is unsuccessful in creating the desired zone, switch 14 may transmit a message to host device 12 indicating that switch 14 was unable to create the desired zone. If switch 14 is successful in creating the desired zone, switch 14 may create a zone including host device 12 and desired target device(s) 18 (as described in more detail below) and further may transmit a message to host device 12 indicating that switch 14 has successfully created the zone.

FIG. 2 illustrates database 30 for storing and maintaining zoning information. Database 30 may physically reside in memory 16, on one more host devices 12, on one or more target devices 18, or at any other location within network 10. Database 30 may include port information 32. Port information 32 may include information associated with each host device 12 and target device 18 coupled to each port 24 of switch 14. For example, port information may include information indicating the unique identifier associated with each host device 12 or target device 18 coupled to network 10. Although database 30 is depicted as using the World Wide Name (WWN) of each host device 12 and target device 18 as the unique identifier of each such device, it is understood that a unique identifier may comprise an Internet protocol (IP) address or medium access control (MAC) address of the respective device, or any other suitable technique for uniquely identifying a device on a network. Port information 32 may also include information indicating the peripheral device type (PDT) of each host device 12 and each target device 18. For example, in the depicted embodiment, port information 32 indicates that host devices 12 coupled to ports 24a and 24b are host devices, target device 18a coupled to port 24c is a tape drive, and target device 18b coupled to port 24d is a disk drive. In other embodiments target devices 18 may include network devices such as network attached storage devices, file servers, print servers, modems, hubs, other information handling systems, and any other device capable of being coupled to network 10. Furthermore, although only four ports are depicted in FIG. 2, it should be understood that port information 32 may also include information for any number of ports.

In addition, database 30 may include zoning configuration information 34. For example, in the depicted embodiment, host device 12a may request access to tape drive storage and disk drive storage and host device 12b may request access to disk drive storage only. In accordance with the methods and systems disclosed herein, a zone identified as “Zone 1” in zoning configuration information 34 may be created which includes host device 12a, target device 18a and target device 18b. Furthermore, a zone identified as “Zone 2” in zoning configuration information 34 may be created which includes host device 12b and target device 18b. In the depicted embodiment, once such zones are created, host device 12a will be able to access all target devices located in Zone 1 (e.g., target device 18a and target device 18b) and host device 12b will be able to access all target devices located in Zone 2 (e.g., target device 18b).

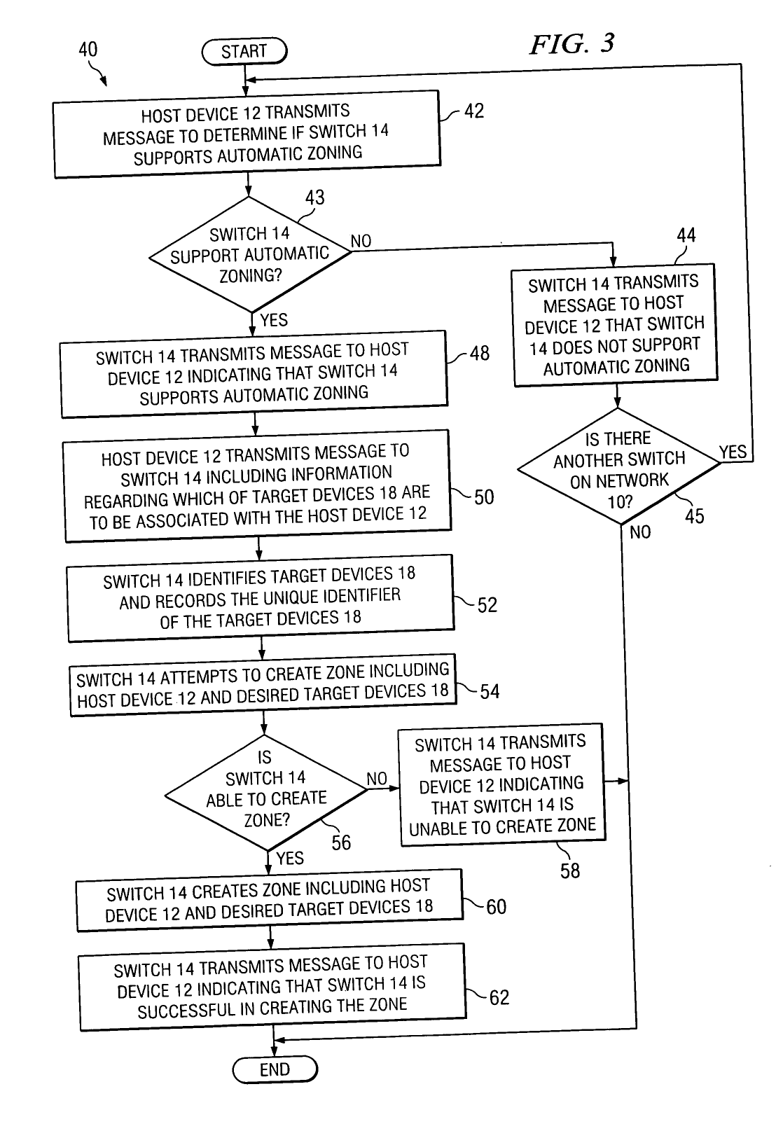

FIG. 3 illustrates a flow chart of method 40 for automatically creating and enabling a zone in a network. In the embodiments disclosed herein, method 40 may be implemented using small computer system interface (SCSI) over Fibre Channel protocol (SCSI FCP) or Fibre Channel Common Transport (FC-CT) protocol, utilizing network 10, host devices 12, target devices 18 and switches 14 that support Fibre Channel standards. Nonetheless, it should be understood that method 40 may, within the scope of the present disclosure, be implemented using other appropriate methods of transmitting media over a network, such as a Frame Relay, Asynchronous Transfer Mode (ATM), Internet protocol (IP), other packet-based protocols, or other transmission protocols and standards.

In one embodiment, method 40 includes a message transmitted from host device 12 to switch 14 to determine if switch 14 supports automatic zoning. If switch 14 supports automatic zoning, it transmits a message to host device 12 indicating that automatic zoning is supported. In response, host device 12 transmits a message to switch 14, which includes information indicating the types of target devices 18 are to be associated with host device 12. Switch 14 attempts to create a zone including host device 12 and the types of target devices indicated. If successful, switch 14 creates the desired zone and transmits a message to host device 12 indicating that the zone was successfully created. If unsuccessful, switch 14 transmits a message to host device 12 indicating that the desired zone could not be created.

According to one embodiment, method 40 preferably begins at step 42. As mentioned above, teachings of the present disclosure may be implemented in a variety of configurations of network 10. As such, the preferred initialization point for method 40 and the order of the steps 42-62 comprising method 40 may depend on the implementation chosen.

At step 42, a host device, such as host device 12, transmits a message to discover switches, such as switch 14, capable of automatic zoning. In one embodiment, the message may be transmitted within a 6-byte control descriptor block (CDB) using SCSI FCP as discussed in greater detail below. In another embodiment, the message may be transmitted within a FC-CT information unit (FC-CT IU) using FC-CT protocol as discussed in greater detail below.

At step 43, a determination is made indicating whether switch 14 supports automatic zoning. If switch 14 does not support automatic zoning, switch 14 transmits a message to host device 12 indicating that switch 14 does not support automatic zoning at step 44. At step 45, a determination is made whether another switch is coupled to network 10. If another switch is coupled to network 10, method 40 proceeds again to step 42. If, at step 45, another switch is not coupled to network 10, method 40 ends.

In one embodiment, step 44 may be implemented in SCSI FCP by transmitting a CHECK CONDITION status from switch 14 to host device 12 indicating that the CDB transmitted at step 42 is invalid. In another embodiment, step 44 may be implemented in FC-CT by transmitting a Fibre Channel Services Reject (FS_RJT) information unit from switch 14 to host device 12 using a reason code of “Command not supported”.

At step 43, if switch 14 supports automatic zoning, switch 14 transmits a message to host device 12 indicating that switch 12 supports automatic zoning at step 48. In one embodiment, step 48 may be implemented in SCSI FCP by transmitting a status from switch 14 to host device 12 indicating a GOOD status. In another exemplary embodiment, step 48 may be implemented in FC-CT by transmitting a Fibre Channel Services Accept (FS_ACC) information unit from switch 14 to host device 12.

At step 50, in response to determining that switch 14 supports automatic zoning, host device 12 transmits a message over network 10 to switch 14. The transmitted message includes information indicating which types of target devices 18 are to be associated with the host device 12. For example, the message may indicate that host device 12 is to be associated with direct-access storage devices, sequential access storage devices, other network attached storage devices, file servers, print servers, modems, hubs and other devices including but not limited to other information handling systems. In one embodiment, the message may be transmitted within a 6-byte CDB using SCSI FCP as discussed in greater detail below. In another embodiment, the message may be transmitted within a FC-CT IU using FC-CT protocol as discussed in greater detail below.

At step 52, switch 14 identifies all target devices 18 of the types indicated in the message transmitted by host device 12, and records the unique identifiers associated with each target device 18. For example, in certain embodiments, unique identifiers for target devices 18 may be recorded in memory 16 and/or database 30.

At step 54, switch 14 attempts to create a zone including the types of target devices 18 indicated in the message transmitted at 50 by host device 12. At step 56, a determination is made indicating whether switch 14 is able to create the desired zone. If switch 14 is unable to create the desired zone, switch 14 transmits a message to host device 12 indicating that switch 14 is unable to create the desired zone at step 58. In one embodiment, step 58 may be implemented in SCSI FCP by transmitting a CHECK CONDITION status from switch 14 to host device 12 indicating that the CDB transmitted through step 54 has failed. In another embodiment, step 58 may be implemented in FC-CT by transmitting a Fibre Channel Services Reject (FS_RJT) information unit from switch 14 to host device 12 using a reason code of “Unable to perform command requested”.

If switch 14 is able to create the desired zone, switch 14 creates the zone including host device 12 and the types of target devices 18 indicated in the transmitted message at step 60. In certain embodiments, switch 14 may logically create the zone by storing zoning information (e.g., the unique identifiers of the target devices 18 and host devices 12 included in the zone, the ports 24 which are coupled to the host devices 12 and target devices 18 included in the zone, and all other information relevant to creating and maintaining the zone) in database 30, memory 16, host devices 12, target devices 18 and/or elsewhere within network 10.

At step 62, switch 14 transmits a message to host device 12 indicating that switch 14 is successful in creating the desired zone, and method 40 ends. In one embodiment, step 62 may be implemented in SCSI FCP by transmitting a status from switch 14 to host device 12 indicating a GOOD status. In another exemplary embodiment, step 62 may be implemented in FC-CT by transmitting a Fibre Channel Services Accept (FS_ACC) information unit from switch 14 to host device 12.

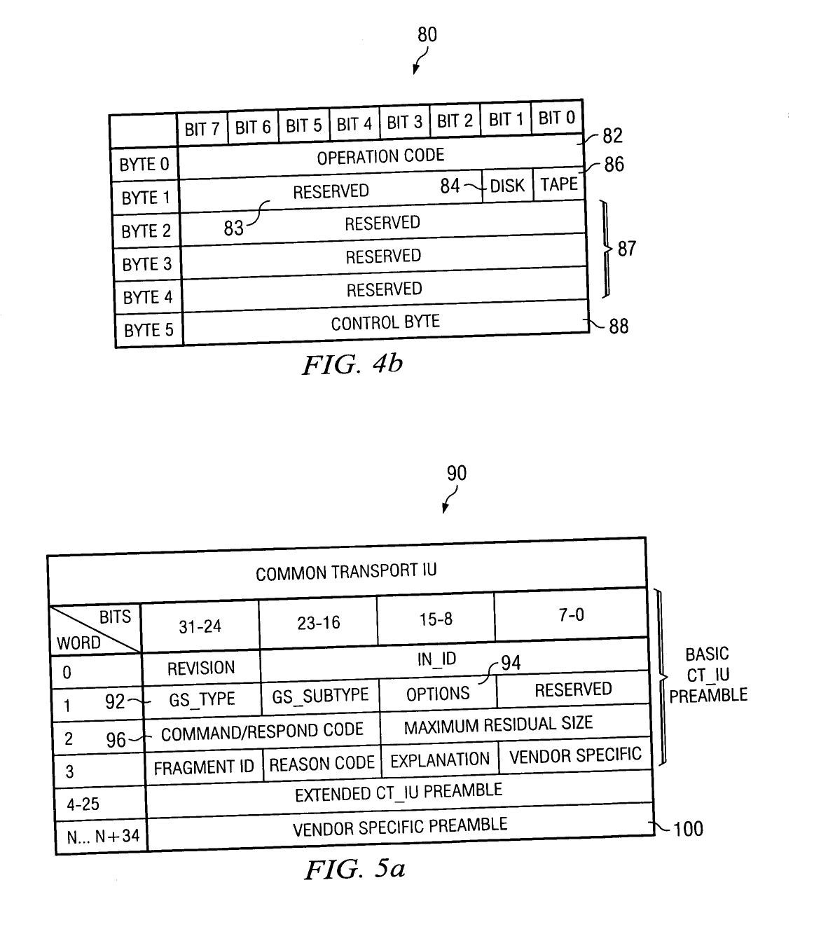

FIG. 4a illustrates a table representing various fields contained within a 6-byte vendor specific control descriptor block (CDB) 70 that may be used to detect switches 14 supporting automated zoning using SCSI FCP. CDB 70 includes an operation code 72. In accordance with SCSI FCP, operation code 72 specifies the operation or command to be performed (e.g., a read from or write operation to a storage device). CDB 72 also includes control byte 78, and reserved fields 76 reserved for particular CDB operations or for future functionality.

To implement step 42 of method 40, CDB 70 may include a vendor specific command (e.g. DAh) in operation code 72 and may be transmitted from host device 12 to switch 14 to determine whether switch 14 supports automatic zoning. If switch 14 supports the vendor specific command (and hence, supports automatic zoning), switch 14 may implement step 48 of method 40 by transmitting a status to host device 12 indicating a GOOD status. On the other hand, if switch 14 does not support the vendor specific command (and hence, does not support automatic zoning), switch 14 may implement step 44 of method 40 by transmitting a vendor specific CHECK CONDITION status to host device 12 indicating that the CDB transmitted at step 42 is invalid.

FIG. 4b illustrates a table representing various fields contained within a 6-byte vendor specific control descriptor block (CDB) 80 that may be used to request automated zoning access to a type of storage device using SCSI FCP. CDB 80 is similar to CDB 70 and may include operation code 82, bit 84, bit 86, control byte 80, and various reserved fields 83, 87.

To implement step 50 of method 40, CDB 80 may include a vendor-specific command (e.g. DBh) in operation code 82. Furthermore, bits 84 and 86 may be set to indicate the target device types that are to be associated with host device 12. For example, if host device 12 is to be associated with one or more direct access storage devices or disk drives, bit 84 may be set to logical value 1; otherwise bit 84 may be set to logical value 0. As a further example, if host device 12 is to be associated with one or more sequential access storage devices or tape drives, bit 86 may be set to logical value 1; otherwise bit 86 may be set to logical value 0. Although only two bits of CDB 80 are depicted in FIG. 4b as indicating the target device types to be associated with host device 12, it is understood that a fewer or greater number of bits of CDB 80, including portions of reserved fields 83 and 87, may be used to indicate the types of target devices to be associated with host device 12 in accordance with the present disclosure. In addition, although FIG. 4b depicts that CDB 80 contains information indicating whether host device 12 is to be associated with tape drives or disk drives, it should be understood that CDB 80 may contain information indication whether a host device is to be associated with other types of target devices, such as other information handling systems, peripherals and all other devices capable of being coupled to network 10.

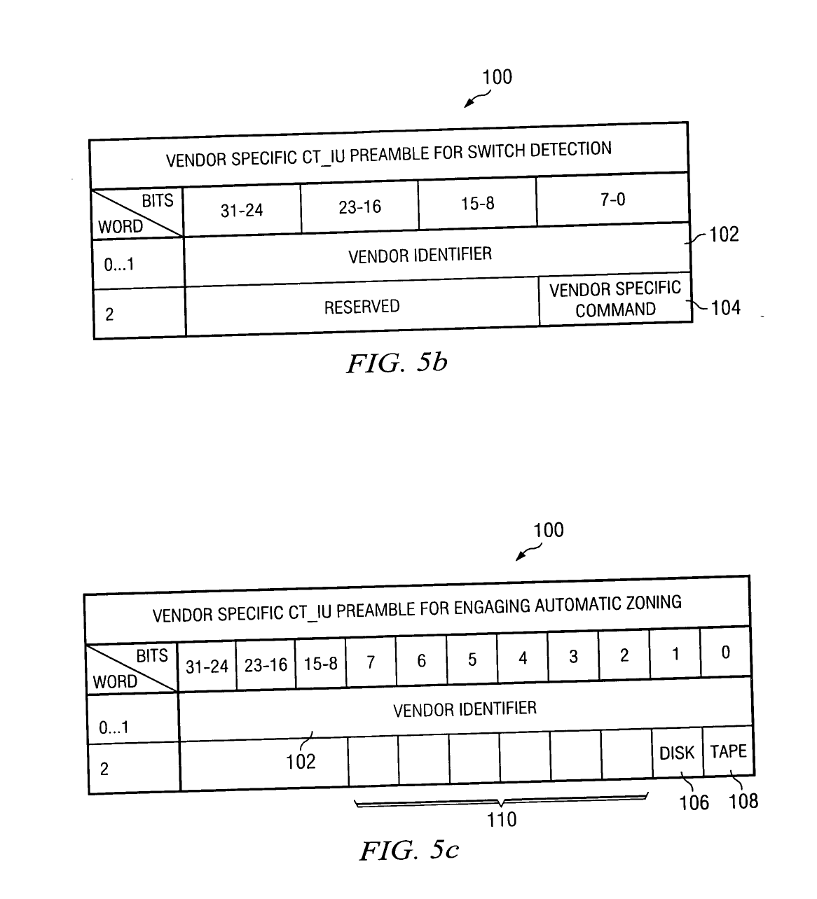

FIG. 5a illustrates a table representing various fields contained within a Fibre Channel Common Transport Information Unit (FC-CT IU) 90 that may be used to implement automatic zoning using FC-CT protocol. FC-CT IU 90 includes GS_Type field 92, Options field 94, Command/Response Code field 96, and Vendor Specific Preamble field 100. In accordance with FC-CT protocol GS_Type field 92 contains an 8-bit value indicating the type of service to be performed by FC-CT IU 90. Furthermore, Options field 94 contains an 8-bit value indicating options to be used by a device in connection with FC-CT IU 90 and Command/Response Code field 96 indicates whether FC-CT IU 90 is a request or a response. If FC-CT IU 90 is a request, Command/Response Code field 96 specifies a command to be performed. If the FC-CT IU 90 is a response, Command/Response Code field 96 indicates whether the request was accepted or rejected. Vendor Specific Preamble field 100 is a 34-word field that specifies a vendor specific command to be performed by FC-CT IU 90, if applicable.

To implement steps 42 and 50 of method 40, GS_Type field 92 may be a hexadecimal value between x00 and x1F to indicate that FC-CT IU 90 contains a vendor specific command. In addition, an appropriate bit of Options field 94 (for example, bit 2) may be set to indicate that FC-CT IU 90 contains a vendor specific command. Furthermore, Command/Response Code field 96 may be a hexadecimal value between x0600 and x7EFF to indicate that FC-CT IU 90 contains a vendor specific preamble. Finally, Vendor Specific Preamble field 100 may contain information indicating that an automatic zoning command is to be executed by FC-CT IU, as set forth in greater detail below.

FIG. 5b illustrates a table representing various fields contained within Vendor Specific Preamble field 100 of a FC-CT IU 90 that may be used to detect switches supporting automated zoning using FC-CT protocol. In accordance with FC-CT protocol, word 0 and word 1 of Vendor Specific Preamble field 100 may contain vendor identifier 102 indicating vendor information associated with the vendor specific command to be executed by FC-CT IU 90. Words 3-33 (not shown) of Vendor Specific Preamble field 100 may contain vendor specific information associated with the vendor specific command to be executed by FC-CT IU 90.

To implement step 42 of method 40, vendor identifier 102 may be set to identify the vendor associated with the automatic zoning command to be executed by FC-CT IU 90. The lowest byte of word 2 may contain a vendor specific command 104 (e.g. DAh) that is transmitted from host device 12 to switch 14 to determine if switch 14 supports automatic zoning. If switch 14 supports the vendor specific command 104 (and hence, supports automatic zoning), switch 14 may implement step 48 of method 40 by transmitting to host device 12 a Fibre Channel Services Accept (FS_ACC) IU. On the other hand, if switch 14 does not support the vendor specific command (and hence, does not support automatic zoning), switch 14 may implement step 44 of method 40 by transmitting to host device 12 a Fiber Channel Services Reject (FS_RJT) IU with a Reason Code of hexadecimal value x0B indicating that vendor specific command 104 is not supported.

Although vendor specific command 104 is depicted in FIG. 5b as residing at the lowest byte of Vendor Specific Preamble field 100, it should be understood that vendor specific command 104 may reside at any location within FC-CT IU 90, including without limitation any location within Vendor Specific Preamble field 100 in accordance with the present disclosure.

FIG. 5c illustrates a table representing various fields contained within Vendor Specific Preamble field 100 of FC-CT IU 90 that may be used to request automated zoning access to various types of target devices using Fibre Channel Common Transport protocol. As in FIG. 5b, word 0 and word 1 of Vendor Specific Preamble field 100 contain vendor identifier 102 indicating vendor information associated with the vendor specific command to be executed by FC-CT IU 90. Words 3-33 (not shown) of Vendor Specific Preamble field 100 contain vendor specific information associated with the vendor specific command to be executed by FC-CT IU 90.

To implement step 50 of method 40, vendor identifier 102 may be set to identify the vendor associated with the automatic zoning command to be executed by FC-CT IU 90. Furthermore, bits 106 and 108 may be set to indicate the target device types that are to be associated with host device 12. For example, if host device 12 is to be associated with one or more direct access storage devices or disk drives, bit 106 may be set to logical value 1; otherwise bit 106 may be set to logical value 0. As a further example, if host device 12 is to be associated with one or more sequential access storage devices or tape drives, bit 108 may be set to logical value 1; otherwise bit 108 may be set to logical value 0. Although only two bits of Vendor Specific Preamble field 100 are depicted in FIG. 5c as indicating the target device types to be associated with host device 12, it should be understood that a fewer or greater number of bits of Vendor Specific Preamble field 100 and FC-CT IU 90, may be used to indicate the types of target devices to be associated with host device 12 in accordance with the present disclosure. In addition, although FIG. 5c depicts that Vendor Specific Preamble field 100 contains information indicating whether host device 12 is to be associated with tape drives or disk drives, it should be understood that FC-CT IU 90 and Vendor Specific Preamble field 100 may contain information indicating whether a host device is to be associated with other types of target devices, such as other information handling systems, peripherals and all other devices capable of being coupled to network 10.

Although the present disclosure as illustrated by the above embodiments has been described in detail, numerous variations will be apparent to one skilled in the art. For example, network 10 may include any number of switching devices 14, host devices 12 and target devices 18. Additionally, any type of suitable communication protocol or standard may be used to implement the methods and systems disclosed herein. It should be understood that various changes, substitutions and alternations can be made herein without departing from the spirit and scope of the disclosure as illustrated by the following claims.

What is claimed is:

1. A system for automatically creating and activating a zone in a network, comprising:
a host device coupled to the network;
a target device coupled to the network; and
a switch coupled to the network and interfaced between the host device and the target device, the switch operable to automatically create a zone including the host device and the target device based on data received from the host device, the data including information indicating that the host device requested access to the target device.

2. The system of claim 1, further comprising a plurality of target devices coupled to the network.

3. The system of claim 2, wherein the switch is interfaced between the host device and the plurality of target devices, the switch further operable to create the zone including the host device and at least one of the target devices based on the data transmitted from the host device.

4. The system of claim 1, wherein the switch is further operable to transmit a message indicating if the switch supports automatic zoning.

5. The system of claim 1, wherein the switch is further operable to store and maintain zoning configuration information.

6. The system of claim 1, wherein the network is capable of utilizing small computer system interface (SCSI) over Fibre Channel protocol.

7. The system of claim 1, wherein the network is capable of utilizing Fibre Channel Common Transport protocol.

8. The system of claim 1, wherein the data received by the switch comprises a device type of the target device.

9. The system of claim 1, wherein the switch is further operable to determine an identifier of the target device.

10. A system for automatically creating and activating a zone in a network, comprising:
a host device coupled to the network;
a storage device coupled to the network; and
a switch coupled to the network and interfaced between the host device and the storage device, the switch operable to automatically create a zone including the host device and the storage device based on data received from the host device, the data including information indicating that the host device requested access to the storage device.

11. The system of claim 10, wherein the storage device comprises a direct access storage device or a sequential access storage device.

12. The system of claim 10, wherein the switch is further operable to transmit a message indicating if the switch supports automatic zoning.

13. The system of claim 10, wherein the switch is further operable to determine if the storage device is interfaced with the switch.

14. A method of automatically creating and activating zone in a network, comprising:
receiving data, at a switch, from a host device, the host device and the switch coupled to the network, the data including information indicating that the host device requested access to at least one target device coupled to the network; and
creating and activating a zone comprising the host device and the at least one target device.

15. The method claim 14, wherein the at least one target device comprises a storage device.

16. The method of claim 14, further comprising determining whether the switch supports automatic zoning.

17. The method of claim 16, further comprising receiving a command at the switch from the host device in response to determining that the switch supports automatic zoning, the command operable to initiate an automatic zoning process.

18. The method of claim 14, wherein the switch is operable to store and maintain zoning configuration information.

19. The method of claim 14, wherein the data transmitted from the host device comprises a device type of the target device.

20. The method of claim 14, wherein the switch is operable to determine an identifier of the at least one target device.
